(19) United States
(12) Patent Application Publication
(10) Pub. No.: US 2025/0376418 A1
(43) Pub. Date: Dec. 11, 2025

(54) PRE-COATING PYROLYSIS CHAR FOR CHAR BRICKS

(71) Applicant: UNIVERSITY OF WYOMING, Laramie, WY (US)

(72) Inventors: Kam Weng NG, Laramie, WY (US); Chooi Kim LAU, Laramie, WY (US)

(21) Appl. No.: 18/878,508

(22) PCT Filed: Jun. 23, 2023
(86) PCT No.: PCT/US2023/026074

§ 371 Date: Dec. 23, 2024

Related U.S. Application Data
(60) Provisional application No. 63/355,020, filed on Jun. 23, 2022.

(51) Int. Cl. C04B 20/10; C04B 18/06; C04B 20/02; C04B 20/04; C10B 57/00

(52) U.S. Cl. CPC C04B 20/1077; C04B 18/065; C04B 20/026; C04B 20/04; C10B 57/005

(57) ABSTRACT

Embodiments of the present disclosure related methods of pre-coating pyrolysis char for use in pyrolysis char bricks. In one method, the method includes forming a cement paste using water and a cement material; soaking a pyrolysis char (PC) in the cement paste to create a coated pyrolysis char (CPC); and sieving the CPC and cement paste with a mesh. In another embodiment, the method includes mixing a PC with a cement material to form a dry mixture; spraying water onto the dry mixture of the PC and the cement material to form a wet mixture; stirring the wet mixture to form a CPC; and drying the CPC. In another embodiment, the method includes soaking a PC in water to form a soaked PC; sieving and vibrating the soaked PC to remove excess water, mixing a cement material with the soaked PC to create a CPC; and drying the CPC.

### BACKGROUND

### Field

Embodiments of the present disclosure generally relate to methods of pre-coating pyrolysis char to fabricate char bricks.

### Description of Related Art

Coal currently serves an important role as an energy source but the increasing demand for renewable energy has reduced the production and consumption of coal in the United States of America (USA). Coal is carbon-rich, and its use in energy generation may affect atmospheric CO₂ levels. The air pollution and global environmental issues associated with the combustion of coal have limited the continuous application of coal in energy production. Specifically, according to the Bureau of Safety and Environmental Enforcement (BSEE), global warming results from various greenhouse gas emissions is partly due to fossil fuel burning, such as the combustion of coal.

Wyoming is one of the major producers of coal in the USA. Wyoming Powder River Basin (PRB) coal plays an important role in the Wyoming energy industry. However, renewable energy is slowly replacing the coal industry, causing the market price of coal to drop. Thus, to attract new investment through technological innovation and support coal mine operations, environmentally friendly methods to create new diversified coal products are needed. One concern about new coal products is characterizing the eco-efficiency of the char products, which includes life-cycle metrics. In addition, the worldwide demand for bricks is rising, and is currently producing about 1,391 billion units.

Pre-coating is an effective method to increase the surface binding strength for aggregates with pozzolanic materials, as being applied to recycled concrete aggregates and fine round slags. The coating thickness can be controlled by varying the cement to water ratio. However, conventional pre-coating processes often lack desirable characteristics.

Accordingly, what is needed in the art are improved methods for pre-coating pyrolysis char to create char bricks.

### SUMMARY

In one embodiment, a method includes forming a cement paste using water and a cement material; soaking a pyrolysis char (PC) in the cement paste to create a coated pyrolysis char (CPC); and sieving the CPC and cement paste with a mesh.

In another embodiment, a method includes mixing a PC with a cement material to form a dry mixture; spraying water onto the dry mixture of the PC and the cement material to form a wet mixture; stirring the wet mixture to form a CPC; and drying the CPC.

In yet another embodiment, a method includes soaking a PC in water to form a soaked PC; sieving and vibrating the soaked PC to remove excess water; mixing a cement material with the soaked PC to create a CPC; and drying the CPC.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1 illustrates a flow diagram of a cement paste method (PM) of pre-coating pyrolysis char (PC), according to embodiments.

FIG. 2 illustrates a flow diagram of a cement spray water method (SW) of pre-coating PC, according to embodiments.

FIG. 3 illustrates a flow diagram of a cement wet method (WM) of pre-coating PC, according to embodiments.

FIG. 4 illustrates a flow diagram of a method of making a pyrolysis char brick (PCB), according to embodiments.

FIG. 5 is a graph illustrating the Brunauer-Emmet-Teller (BET) specific surface area of the PC and the PM coated pyrolysis char (CPC) samples, according to embodiments.

FIG. 6 is a graph illustrating the Fourier Transform Infrared (FTIR) spectroscopy comparison of the PC and PM CPC samples, according to embodiments.

FIG. 7A is a micrograph illustrating a PC sample, according to embodiments.

FIG. 7B is a micrograph illustrating the 0.2:1 cement material to water ratio PM CPC sample, according to embodiments.

FIG. 7C is a micrograph illustrating the 0.5:1 cement material to water ratio PM CPC sample, according to embodiments.

FIG. 7D is a micrograph illustrating the 0.8:1 cement material to water ratio PM CPC sample, according to embodiments.

FIG. 7E is a micrograph illustrating the 1:1 cement material to water ratio PM CPC sample, according to embodiments.

FIG. 8 is a graph illustrating a thermogravimetric analysis (TGA) of a PC sample, according to embodiments.

FIG. 9 is a graph illustrating a TGA of a SW CPC sample, according to embodiments.

FIG. 10 is a graph illustrating a TGA of a WM CPC sample, according to embodiments.

FIG. 11A is a scanning electron microscope (SEM) micrograph of the PC samples at 300 μm, according to embodiments.

FIG. 11B is a SEM micrograph illustrating the PC samples at 50 μm, according to embodiments.

FIG. 11C is an energy-dispersive x-ray spectroscopy (EDS) micrograph illustrating the carbon content of PC samples at 100 μm, according to embodiments.

FIG. 11D is an EDS micrograph illustrating the calcium content of PC samples at 100 μm, according to embodiments.

FIG. 12A is a SEM micrograph illustrating the SW CPC samples at 300 μm, according to embodiments.

FIG. 12B is a SEM micrograph illustrating the SW CPC samples at 50 μm, according to embodiments.

FIG. 12C is an EDS micrograph illustrating the carbon content of SW CPC samples at 100 μm, according to embodiments.

FIG. 12D is an EDS micrograph illustrating the calcium content of SW CPC samples at 100 μm, according to embodiments.

FIG. 13A is a SEM micrograph illustrating the WM CPC samples at 300 μm, according to embodiments.

FIG. 13B is a SEM micrograph illustrating the WM CPC samples at 50 μm, according to embodiments.

FIG. 13C is an EDS micrograph illustrating the carbon content of WM CPC samples at 100 μm, according to embodiments.

FIG. 13D is an EDS micrograph illustrating the calcium content of WM CPC samples at 100 μm, according to embodiments.

FIG. 14 is a graph illustrating the compressive strength PCBs formed with PM CPC, according to embodiments.

FIG. 15 is a graph illustrating the compressive strength PCBs formed with CPC, according to embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to methods of pre-coating pyrolysis char to fabricate char bricks. In one embodiment, a cement paste method is described herein. In another embodiment, a cement spray water method is described herein. In another embodiment, a cement wet method is described herein.

The inventors have found new and improved methods for fabricating bricks from raw coal by pre-coating pyrolysis char (PC) with cement materials. Briefly, raw coal is thermo-chemically converted to produce pyrolysis char, and the resulting pyrolysis char is then converted to pyrolysis char bricks (PCBs).

The desire for environmentally-friendly materials, energy savings, and reduced energy consumption in building materials can be addressed by the building materials described herein. Building materials made with pyrolysis char (PC) have reduced density, increased strength, reduced thermal conductivity, and increased insulative properties when compared to conventional materials, such as clay bricks. There materials, trough recycling/reuse and decreasing the amount of energy usage in fabrication, further lessens the environmental impact of the PCBs. Pre-coating PC to create coated pyrolysis char (CPC) increases the surface binding strength for aggregates with pozzolanic materials. An increase in surface binding may result in increased compressive strength, flexural strength, and tensile strength, as well as freeze-thaw durability.

The use of headings is for purposes of convenience and does not limit the scope of the present disclosure. Embodiments described herein can be combined with other embodiments.

As used herein, a “composition” can include component(s) of the composition, reaction product(s) of two or more components of the composition, a remainder balance of remaining starting component(s), or combinations thereof. Compositions of the present disclosure can be prepared by any suitable mixing process.

### Compositions

Embodiments described herein generally relate to methods of forming a composition, e.g., a pyrolysis char brick (PCBs), formed using coated pyrolysis char (CPC). The PCBs can be formed using CPC, a cement material, sand, and water. The CPC, cement material, and sand make a mixture of dry ingredients. The mixture of dry ingredients include about 30% to about 80% CPC, about 0% to about 30% sand, and about 15% to about 60% cement material, by weight. The cement material acts as a binder. The cement material includes ordinary Portland cement (OPC). The standard specifications for the OPC can be found in ASTM C150. The sand may be coarse aggregate (e.g., a grain size from about 10 mm to about 63 mm in diameter) or fine aggregate (less than about 8 mm in diameter).

PC is a solid residue from a pyrolysis process of coal. The PC has a particle size distribution from about 50 μm to about 500 μm. The CPC has a Brunauer, Emmett and Teller (BET) specific surface area of about 100 m²/g to about 300 m²/g. The pore volume of the CPC is from about 0.01 cm³/g to about 0.2 cm³/g. The CPC has a micropore area from about 50 m²/g to about 300 m²/g. The CPC has external surface area of about 30 m²/g to about 50 m²/g. The CPC has an adsorption average pore diameter of about 1.0 nm to about 2.0 nm. The CPC has a desorption average pore diameter of about 1 nm to about 50 nm.

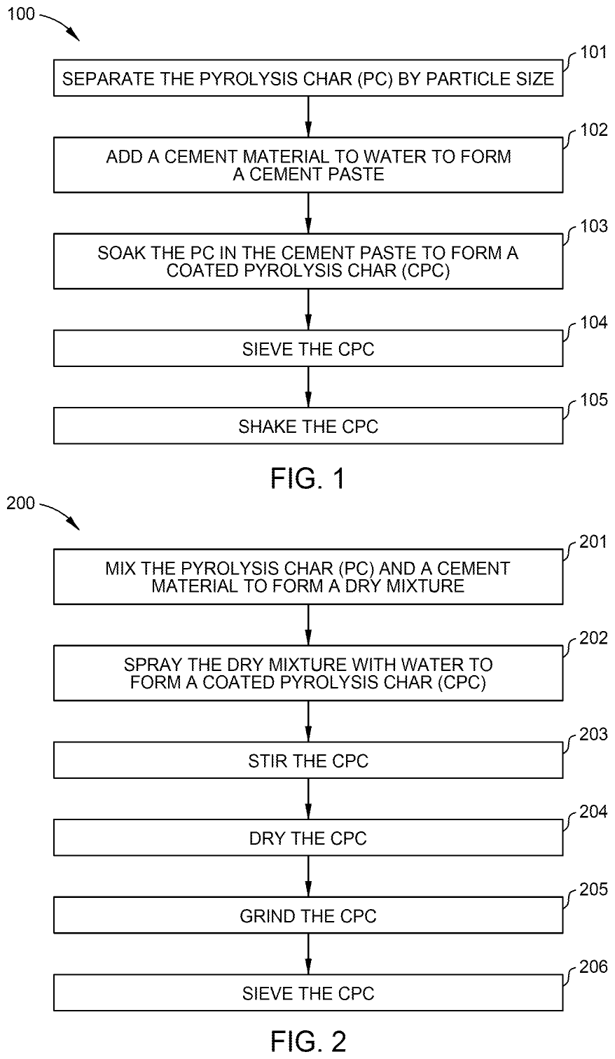

FIG. 1 illustrates a flow diagram of a cement paste method (PM) of pre-coating PC. At operation 101, the PC is separated into different particle sizes. The difference in particle sizes of the PC account for the effect of the cement material to water ratio by preparing different cement pastes with varying mass ratio of cement to water. At operation 102, a cement material is added to water to form a cement paste. The cement material to water ratio is from about 0.2:1 to about 1:1. The cement material to water ratio determines the flowability and workability of the past.

At operation 103, the PC is soaked in the cement paste to form a coated pyrolysis char (CPC). The PC may be soaked in the cement paste for about 15 seconds to about 90 seconds. Soaking the PC in the cement paste helps to prevent the blockage of the PC pores. Further, the soaking of the PC in the cement paste ensured proper impregnation of the cement paste on the surface of the PC.

At operation 104, the CPC is sieved. The CPC is sieved to avoid excess coating of the PC with unremoved cement. The sieve has a mesh size from about 0.1 mm to about 0.5 mm, such as about 0.3 mm. At operation 105, the CPC is shaken. The CPC is shaken to remove excess cement paste from the surface of the CPC.

FIG. 2 illustrates a flow diagram of a cement spray water method (SW) of pre-coating pyrolysis char (PC). At operation 201, the PC is mixed with a cement material to form a dry mixture. The PC to cement material ratio is from about 1.5:1 to about 4:1. The PC and cement material are mixed for about 30 seconds to about 120 seconds. At operation 202, the dry mixture is sprayed with water to form a coated PC (CPC). The dry mixture is sprayed until the surface of the dry mixture becomes wet. The spraying of the dry mixture controls the amount of cement material that sticks to the surface of the PC and to avoid agglomeration.

At operation 203, the CPC is stirred. The stirring of the CPC ensures that the surface of the PC is wetted with the cement material. At operation 204, the CPC is dried. The CPC may be dried in an oven at a temperature from about 30° C. to about 50° C., such as about 40° C. The CPC is dried from about 24 hours to about 72 hours, such as about 48 hours. After drying in the oven, the CPC is dried at room temperature for about 1 hour to about 3 hours.

At operation 205, the CPC is ground. Grinding the CPC separates agglomerations of the CPC. At operation 206, the CPC is sieved. The CPC is sieved to avoid excess coating of the PC with unremoved cement. The sieve has a mesh size from about 0.1 mm to about 0.5 mm, such as about 0.3 mm.

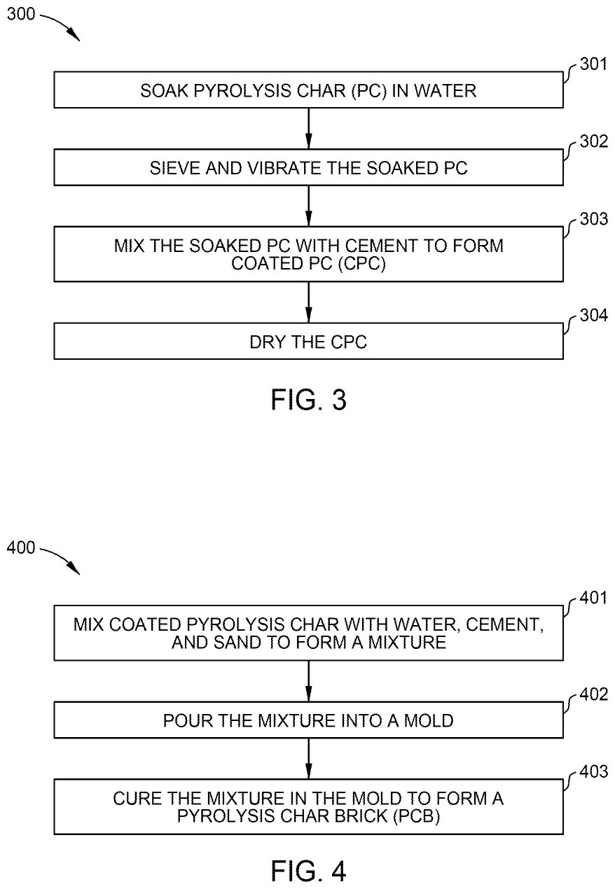

FIG. 3 illustrates a flow diagram of a cement wet method (WM) of pre-coating PC. At operation 301, PC is soaked in water. The water covers and fills the pores of the PC, enhancing the adhesion of the PC to the cement material.

At operation 302, the soaked PC is sieved and vibrated. The sieving and vibrating removes excess water from the soaked PC. The soaked PC is sieved with a mesh size from about 0.1 mm to about 0.2 mm, such as about 0.15 mm. The vibration occurs for about 15 second to about 120 seconds, such as about 30 seconds.

At operation 303, the soaked PC is mixed with a cement material to form a coated PC (CPC). The ratio of PC to cement material is from about 2.5:1 to about 4:1.

At operation 304, the CPC is dried. The CPC may be dried in an oven at a temperature of 30° C. to about 50° C., such as about 40° C. The CPC is dried from about 24 hours to about 72 hours, such as about 48 hours. After drying in the oven, the CPC is dried at room temperature for about 1 hour to about 3 hours.

FIG. 4 illustrates a flow diagram of a method of making a pyrolysis char brick (PCB). At operation 401, the CPC is mixed with cement, sand, and water to form a mixture. At operation 402, the mixture is poured into a mold. At operation 403, the mixture is cured in the mold to form a pyrolysis char brick (PCB). The PCBs formed using the CPC have a compressive strength from about 1 MPa to about 20 MPa.

### Uses

Embodiments of the present disclosure also generally relate to uses of the compositions described herein. Compositions described herein can also be used for various applications.

Illustrative, but non-limiting, applications include concrete masonry units such as cinder blocks, breezeblocks, hollow blocks, concrete blocks, construction blocks, Besser blocks, clinker blocks, among other concrete masonry units.

The following examples are put forth so as to provide those of ordinary skill in the art with a complete disclosure and description of how to make and use embodiments of the present disclosure, and are not intended to limit the scope of embodiments of the present disclosure. Efforts have been made to ensure accuracy with respect to numbers used by some experimental errors and deviations should be accounted for.

### EXAMPLES

### Test Methods

The BET analysis of the CPC is performed using an Autosorb IQ gas absorption analyzer by Quantachrome. The BET analysis was performed using ASTM D6556-21.

The Fourier Transform Infrared Spectroscopy (FTIR) is measured using a nicolet iS50 FTIR spectrometer from Thermo Scientific.

The Scanning Electron Microscopy (SEM) is measured using FEI Quanta 250 Conventional SEM.

The thermogravimetric analysis (TGA) is performed using TA instrument Q500.

The energy-dispersive x-ray spectroscopy (EDS) was performed using an Oxford instruments X-MaxN energy dispersive X-ray spectroscopy detector.

The compressive strength of the PCBs was measured using a Gilson AC-250NMR. The compressive strength of the PCBs was measured using ASTM C67.

### Experimental

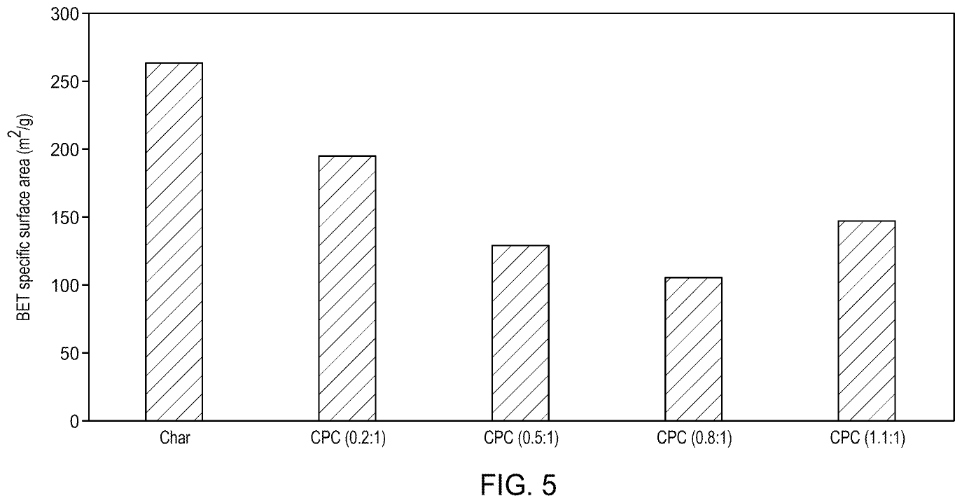

Table 1 is a summary of the results of the BET analysis for pyrolysis char (PC) and paste method (PM) coated pyrolysis char (CPC). The PM CPC was formed into samples with cement to water ratios of 0.2:1, 0.5:1, 0.8:1, and 1:1. FIG. 5 is a graph illustrating the BET specific surface area of the PM CPC samples. The PM CPC samples are formed using method 100. The PM CPC samples are formed with cement to water ratios of 0.2:1, 0.5:1, 0.8:1, and 1:1. The PC was soaked in the cement paste for 30 seconds. A sieve with a mesh size of 0.3 mm was used to sieve the PM CPC samples.

TABLE 1
Summary of the BET Analysis for PC and CPC.

| Properties | PC | 0.2:1 | 0.5:1 | 0.8:1 | 1:1 |
|---|---|---|---|---|---|
| BET Surface Area (m²/g) | 262.17 | 195.21 | 128.32 | 104.74 | 145.60 |
| t-plot Micropore Area (m²/g) | 209.20 | — | 68.03 | 76.20 | 104.33 |
| t-plot External Surface Area (m²/g) | 52.97 | — | 60.29 | 28.54 | 41.28 |
| t-plot Micropore Volume (cm³/g) | 0.08 | — | 0.03 | 0.03 | 0.04 |
| Adsorption Average Pore Diameter | 1.40 | 1.40 | 1.26 | 1.37 | 1.37 |
| (4V/A by BET): (nm) | | | | | |
| Desorption Average Pore Diameter | 30.31 | 42.07 | 59.76 | 64.03 | 13.20 |
| (4V/A by BET): (nm) | | | | | |

The specific surface areas of all the PM CPC samples are less than that of the raw pyrolysis char (PC). Since all the deposited samples have vast micropores and mesopores from the nitrogen porosimetry, the cement paste deposited on the wall of the pores when the PC was soaked in the cement paste for 30 seconds. The viscosity and hardening time of the cement paste increased with the increase in cement to water ratio. Therefore, the reduction of the specific surface area, as well as pore volume, for the PM CPC obtained from the cement paste with 0.2:1 to 0.8:1 cement to water ratios is attributed to the blockage of the pores and subsequent reduction of deposition of the cement paste on the wall of the pores. However, the PM CPC for the cement paste with the 1:1 cement to water ratio demonstrates higher specific area than those of the PM CPC samples from 0.5:1 and 0.8:1 cement to water ratios due to the fast hardening of the high viscosity cement paste.

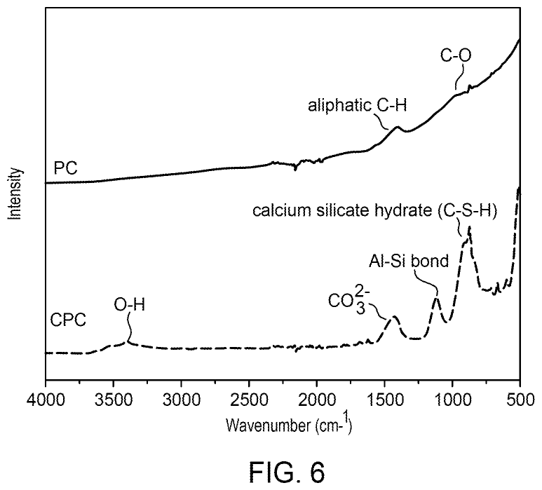

FIG. 6 is a graph illustrating the Fourier Transform Infrared (FTIR) spectroscopy for a PM CPC sample. The PM CPC sample has a cement to water ratio of 0.8:1. The characteristic peaks for cement including C—SH, Al—Si, and carbonate bonds are observed from the PM CPC sample, which demonstrates that the cement paste has been successfully coated over the surface of the PCs.

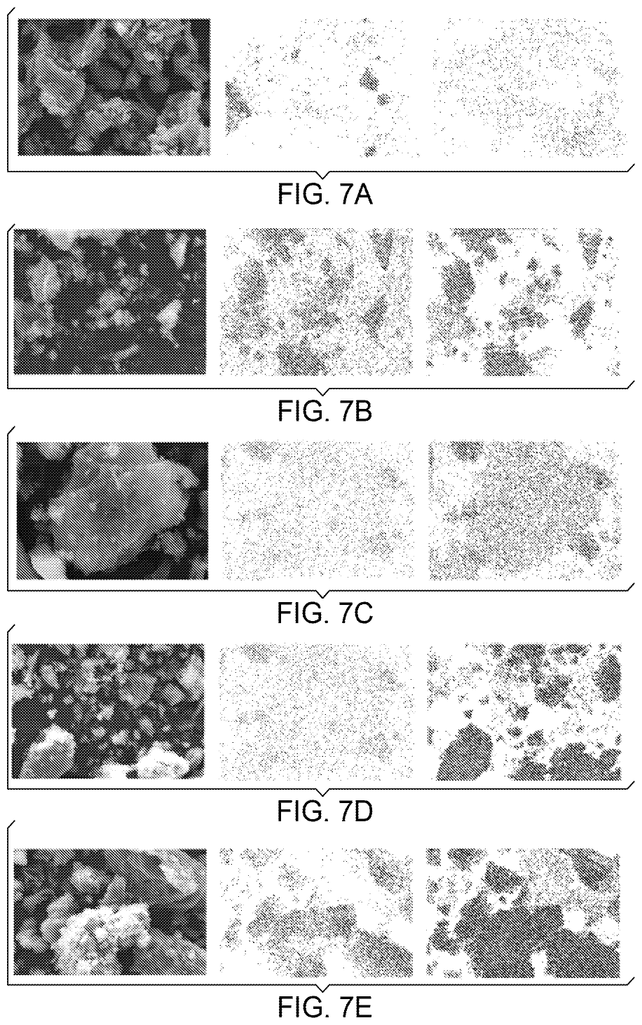

The uncoated PC is distinguished from PM CPC is through x-ray mapping. The x-ray maps of silica (Si) and calcium (Ca) elements are present, which illustrates the cement coating, in each PM CPC sample. FIG. 7A is a micrograph illustrating a PC sample. FIG. 7B is a micrograph illustrating the 0.2:1 cement to water ratio PM CPC sample. FIG. 7C is a micrograph illustrating the 0.5:1 cement to water ratio PM CPC sample. FIG. 7D is a micrograph illustrating the 0.8:1 cement to water ratio PM CPC sample. FIG. 7E is a micrograph illustrating the 1:1 cement to water ratio PM CPC sample. It can be qualitatively seen that the cement paste coating on PC has introduced additional silica and calcium elements from the cement to the PC surface.

Table 2 is a comparison of the pore properties of uncoated PC samples, SW CPC samples, and WM CPC samples. The SW CPC samples are formed using the method 200. The PC and cement material are mixed for 60 seconds. The SW CPC is dried in an oven at 40° C. for up to 48 hours then air dried at room temperature. The WM CPC samples are formed using method 300. The soaked PC is sieve with a 0.15 mm sieve and vibrated for 30 seconds. The WM CPC is dried in an oven at 40° C. for up to 48 hours then air dried at room temperature.

TABLE 2

| | PC (0.300- | | |
|---|---|---|---|
| Properties | 0.425 mm) | SW - CPC | WM-CPC |
| BET Surface Area (m²/g) | 305.36 | 281.34 | 279.39 |
| t-plot Micropore Area (m²/g) | 239.53 | 241.21 | 241.84 |
| t-plot External Surface Area (m²/g) | 65.83 | 40.12 | 37.55 |
| t-plot Micropore Volume (cm³/g) | 0.12 | 0.10 | 0.10 |
| Adsorption Average Pore Diameter | 1.61 | 1.53 | 1.53 |
| (4V/A by BET): (nm) | | | |
| Desorption Average Pore Diameter | 2.80 | 3.28 | 2.50 |
| (4V/A by BET): (nm) | | | |

The pore volume and the BET surface area of the SW CPC samples and WM CPC samples are less than the pore volume of the PC sample. The lower pore volume and BET surface area demonstrate that the cement coats the PC surface and thus reduces the specific surface area.

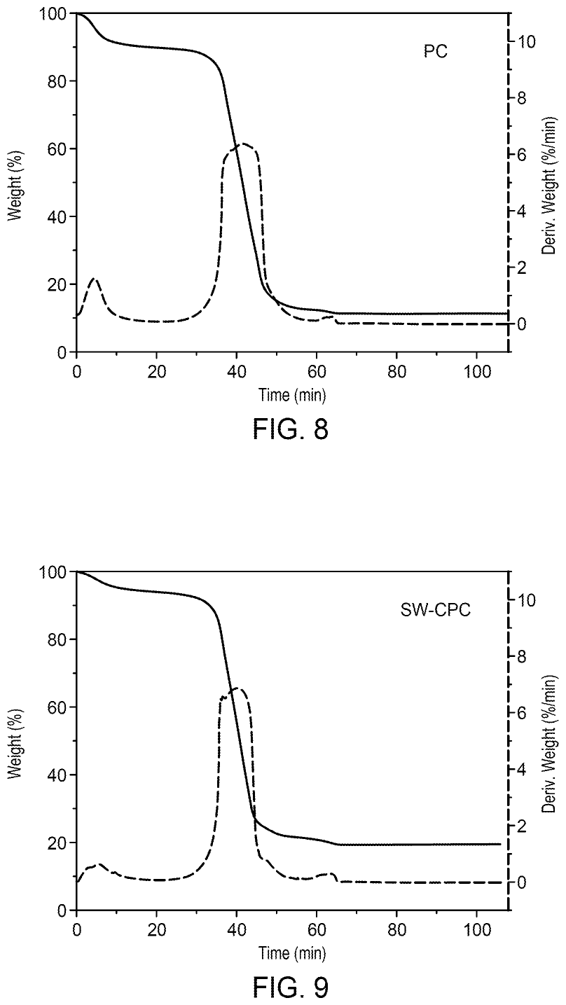

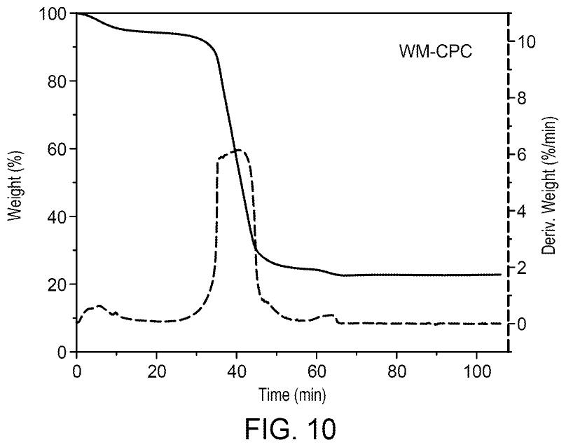

FIG. 8 is a graph illustrating the thermogravimetric analysis of PC samples. FIG. 9 is a graph illustrating the thermogravimetric analysis of SW CPC samples. FIG. 10 is a graph illustrating the thermogravimetric analysis of WM CPC samples. Thermogravimetric analysis (TGA) was conducted on PC samples, SW CPC samples, and the WM CPC samples. The PC, SW CPC samples, and the WM CPC samples were burned in air at about 800° C. for 30 minutes. The mass left in the crucibles attributes to ash. The PC samples had an ash content of 11.36%. The SW CPC samples had an ash content of 19.6%. The WM CPC samples had an ash content of 22.73%. The cement coating on SW CPC samples and WM CPC samples resulted in an increased ash rate when compared to that of the PC sample. The WM CPC had an increased ash content compared to the SW CPC samples, which may indicate increased cement material coating on the PC.

According to the elemental analysis summarized in Table 3, the SW-CPC samples showed a lower value of carbon content than the PC sample. The lower carbon content demonstrates that the PC has been coated by the cement material, resulting in a decreased carbon content.

TABLE 3
Summary of the Elemental Analysis of uncoated
PC samples, SW CPC samples, and WM CPC samples.

Ultimate analysis (w/w %)

| Sample | N | C | O (diff.) | H | S |
|---|---|---|---|---|---|
| PC | 0.8 | 69.93 | 7.9 | 1.59 | 0.42 |
| SW-CPC | 0.83 | 65.99 | 8.14 | 1.27 | 0.57 |
| WM-CPC | 0.82 | 65.5 | 5.66 | 1.21 | 0.58 |

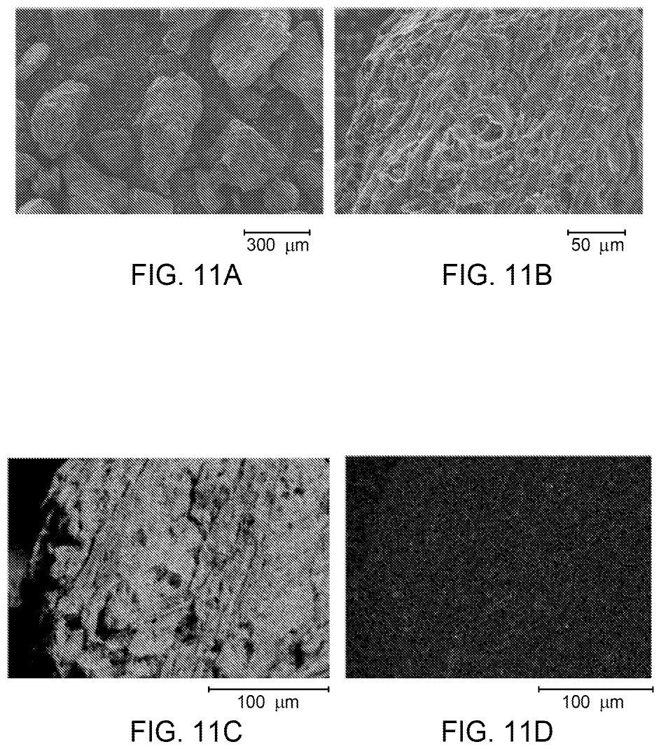

FIG. 11A is a scanning electron microscope (SEM) micrograph illustrating the PC samples at 300 μm. FIG. 11B is a scanning electron microscope (SEM) micrograph illustrating the PC samples at 50 μm. FIG. 11C is an energy-dispersive x-ray spectroscopy (EDS) micrograph illustrating the carbon content of PC samples at 100 μm. FIG. 11D is an EDS micrograph illustrating the calcium content of PC samples at 100 μm. The PC samples have a porous structure, high carbon content, and low calcium content.

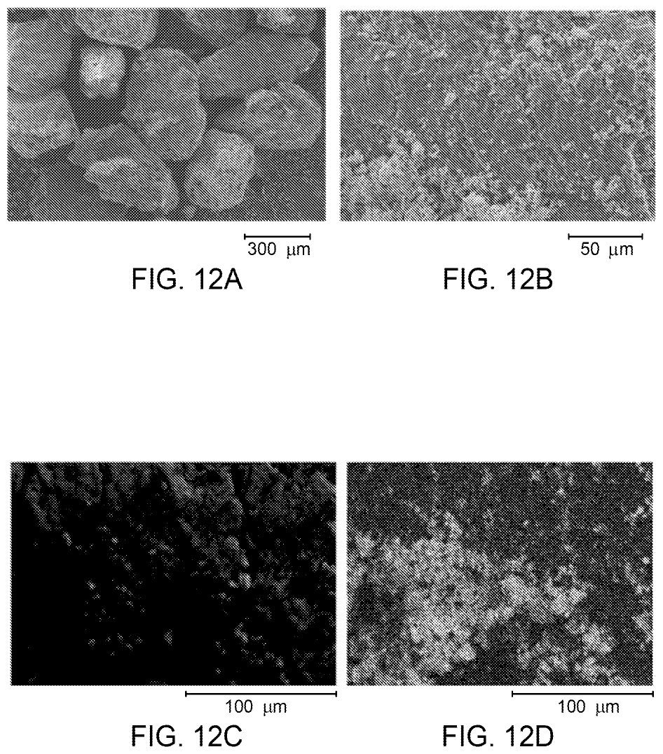

FIG. 12A is a scanning electron microscope (SEM) micrograph illustrating the SW CPC samples at 300 μm. FIG. 12B is a scanning electron microscope (SEM) micrograph illustrating the SW CPC samples at 50 μm. FIG. 12C is an EDS micrograph illustrating the carbon content of SW CPC samples at 100 μm. FIG. 12D is an EDS micrograph illustrating the calcium content of SW CPC samples at 100 μm. The carbon content of the SW CPC samples decreases compared to the PC samples, while the calcium content increases, demonstrating that the cement has coated the SW CPC samples.

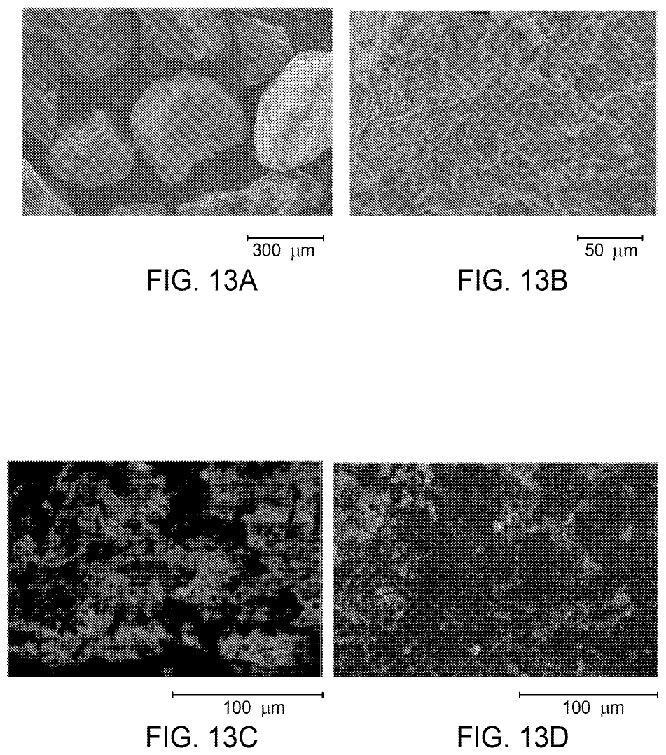

FIG. 13A is a scanning electron microscope (SEM) micrograph illustrating the WM CPC samples at 300 μm. FIG. 13B is a scanning electron microscope (SEM) micrograph illustrating the WM CPC samples at 50 μm. FIG. 13C is an EDS micrograph illustrating the carbon content of WM CPC samples at 100 μm. FIG. 13D is an EDS micrograph illustrating the calcium content of WM CPC samples at 100 μm. The carbon content of the WM CPC samples decreases compared to the PC samples, while the calcium content increases, demonstrating that the cement has coated the WM CPC samples.

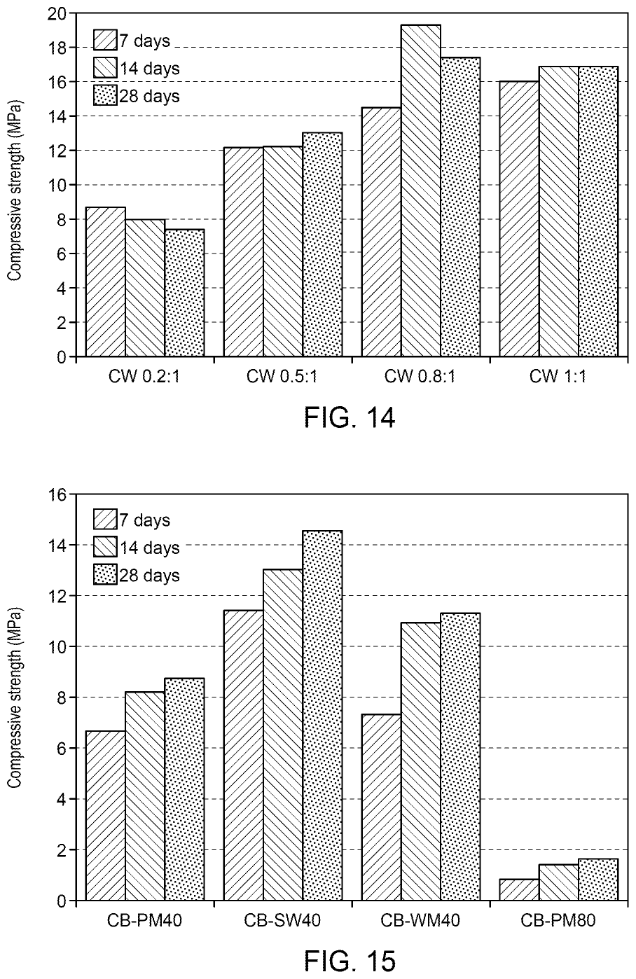

FIG. 14 is a graph illustrating the compressive strength PCBs formed with PM CPC. The PM CPC had varying cement material to water ratios, creating a PCB with a 0.2:1 cement material to water ratio sample (CW 0.2:1), a PCB with a 0.5:1 cement material to water ratio sample (CW 0.5:1), a PCB with a 0.8:1 cement material to water ratio sample (CW 0.8:1), and a PCB with a 1:1 cement material to water ratio sample (CW 1:1). The PCBs were cured at a temperature of 25° C. with a humidity of about 75%. The PCBs have a weight percentage of 37.5% CPC, 25% cement material, and 37.5% sand. The strength of the PCBs was measured at 7 days, 14 days, and 28 days. The CW 0.8:1 PCBs had the largest compressive strength after 14 days and 28 days of drying.

FIG. 15 is a graph illustrating the compressive strength PCBs formed with CPC. Table 4 is a summary of the contents of the PCB samples. The samples were formed using the SM CPCs, the WM CPCs, and the PM CPCs. The cement material, CPC, and sand aggregate are first mixed at room temperature. Water is added; and the mixture is stirred for 3 minutes. The slurry mixture is transferred to brick molds, followed with air dry for 24 to 48 hours before curing. The produced bricks are cured in a wet room at room temperature and relative humidity of 75%. Two PM CPC PCBs are formed with contents of 40 w/w % and 85 w/w % PM CPC.

TABLE 4
Summary of the Contents of the PCB Samples.

| Brick sample ID | CPC | Cement | Sand aggregate |
|---|---|---|---|
| CB-PM40 | 40% | 25% | 35% |
| CB-PM85 | 85% | 15% | 0% |
| CB-WM40 | 40% | 25% | 35% |
| CB-SW40 | 40% | 25% | 35% |

The 7-, 14-, and 28-day mechanical compressive strength of the CPC-based bricks were measured. The SW40 brick samples exhibited the highest compressive strength. Decreasing the CPC from 85% to 40% at an increased cement content and using sand aggregate increases the compressive strength of the CPC PCBs.

### Embodiments Listing

The present disclosure provides, among other things, the following embodiments, each of which can be considered as optionally including any alternate embodiment.

Clause 1. A method of pre-coating pyrolysis ash, the method comprising:
forming a cement paste using water and a cement material;
soaking a pyrolysis char (PC) in the cement paste to create a coated pyrolysis char (CPC); and
sieving the CPC and cement paste with a mesh.

Clause 2. The method of clause 1, wherein a ratio of cement to water is between about 0.2:1 and about 1:1.

Clause 3. The method of clause 1, wherein a mesh size of the mesh is about 0.1 mm to about 0.5 mm.

Clause 4. The method of clause 1, wherein the PC is soaked in the cement paste for about 15 seconds to about 90 seconds.

Clause 5. The method of clause 1, further comprising shaking the CPC after sieving the CPC.

Clause 6. A method of pre-coating pyrolysis ash, the method comprising:
mixing a pyrolysis char (PC) with a cement material to form a dry mixture;
spraying water onto the dry mixture of the PC and the cement material to form a wet mixture;
stirring the wet mixture to form a coated pyrolysis char (CPC); and
drying the CPC.

Clause 7. The method of clause 6, further comprising gently grinding the CPC after drying the CPC.

Clause 8. The method of clause 7, further comprising sieving the CPC after grinding the CPC.

Clause 9. The method of clause 6, wherein the CPC is dried in an oven at about 30° C. to about 50° C. for about 24 hours to about 72 hours.

Clause 10. The method of clause 9, wherein the CPC is dried at room temperature C for about 1 hour to about 3 hours after drying in the oven.

Clause 11. A method of pre-coating pyrolysis ash, the method comprising:
soaking a pyrolysis char (PC) in water to form a soaked PC;
sieving and vibrating the soaked PC to remove excess water;
mixing a cement material with the soaked PC to create a coated pyrolysis char (CPC); and
drying the CPC.

Clause 12. The method of clause 11, wherein the CPC is dried in an oven at about 30° C. to about 50° C. for about 24 hours to about 72 hours.

Clause 13. The method of clause 12, wherein the CPC is dried at room temperature C for about 1 hour to about 3 hours after drying in the oven.

Clause 14. The method of clause 11, wherein the soaked PC is sieved with a mesh having a mesh size from about 0.1 mm to about 0.2 mm.

Clause 15. The method of clause 11, wherein the vibrating occurs for about 15 second to about 120 seconds.

Clause 16. The method of claims 1-15, wherein the PC has a particle size distribution from about 50 μm to about 500 μm.

Clause 17. The method of claims 1-15, wherein the CPC has a Brunauer, Emmett and Teller (BET) specific surface area of about 100 m²/g to about 300 m²/g.

Clause 18. The method of claims 1-15, wherein the pore volume of the CPC is from about 0.01 cm³/g to about 0.2 cm³/g.

Clause 19. The method of claims 1-15, wherein the CPC has a micropore area from about 50 m²/g to about 300 m²/g.

Clause 20. The method of claims 1-15, wherein the CPC has external surface area of about 30 m²/g to about 50 m²/g.

Clause 21. The method of claims 1-15, wherein the CPC has an adsorption average pore diameter of about 1.0 nm to about 2.0 nm.

Clause 22. The method of claims 1-15, wherein the CPC has a desorption average pore diameter of about 1 nm to about 50 nm.

Clause 23. The method of claims 1-15, further comprising:
mixing the CPC is mixed with cement, sand, and water to form a mixture;
pouring the mixture into a mold.
curing the mixture in the mold to form a pyrolysis char brick (PCB).

Clause 23. The method of 23, wherein the PCBs have a compressive strength from about 1 MPa to about 20 MPa.

As is apparent from the foregoing general description and the specific aspects, while forms of the aspects have been illustrated and described, various modifications can be made without departing from the spirit and scope of the present disclosure. Accordingly, it is not intended that the present disclosure be limited thereby. Likewise, the term “comprising” is considered synonymous with the term “including.” Likewise whenever a composition, process operation, process operations, an element or a group of elements is preceded with the transitional phrase “comprising,” it is understood that we also contemplate the same composition or group of elements with transitional phrases “consisting essentially of,” “consisting of,” “selected from the group of consisting of,” or “Is” preceding the recitation of the composition, process operation, process operations, element, or elements and vice versa, such as the terms “comprising,” “consisting essentially of,” “consisting of” also include the product of the combinations of elements listed after the term.

For purposes of this present disclosure, and unless otherwise specified, all numerical values within the detailed description and the claims herein are modified by “about” or “approximately” the indicated value, and consider experimental error and variations that would be expected by a person having ordinary skill in the art. For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. For example, the recitation of the numerical range 1 to 5 includes the subranges 1 to 4, 1.5 to 4.5, 1 to 2, among other subranges. As another example, the recitation of the numerical ranges 1 to 5, such as 2 to 4, includes the subranges 1 to 4 and 2 to 5, among other subranges. Additionally, within a range includes every point or individual value between its end points even though not explicitly recited. For example, the recitation of the numerical range 1 to 5 includes the numbers 1, 1.5, 2, 2.75, 3, 3.80, 4, 5, among other numbers. Thus, every point or individual value may serve as its own lower or upper limit combined with any other point or individual value or any other lower or upper limit, to recite a range not explicitly recited.

While the foregoing is directed to embodiments of the present disclosure, other and further embodiments of the disclosure may be devised without departing from the basic scope thereof.

What is claimed is:

1. A method of pre-coating pyrolysis char, the method comprising:
forming a cement paste using water and a cement material;
soaking a pyrolysis char (PC) in the cement paste to create a coated pyrolysis char (CPC); and
sieving the CPC and cement paste with a mesh.

2. The method of claim 1, wherein a ratio of cement to water is between about 0.2:1 and about 1:1.

3. The method of claim 1, wherein a mesh size of the mesh is about 0.1 mm to about 0.5 mm.

4. The method of claim 1, wherein the PC is soaked in the cement paste for about 15 seconds to about 90 seconds.

5. The method of claim 1, further comprising shaking the CPC after sieving the CPC.

6. A method of pre-coating pyrolysis char, the method comprising:
mixing a pyrolysis char (PC) with a cement material to form a dry mixture;
spraying water onto the dry mixture of the PC and the cement material to form a wet mixture;
stirring the wet mixture to form a coated pyrolysis char (CPC); and
drying the CPC.

7. The method of claim 6, further comprising gently grinding the CPC after drying the CPC.

8. The method of claim 7, further comprising sieving the CPC after grinding the CPC.

9. The method of claim 6, wherein the CPC is dried in an oven at about 30° C. to about 50° C. for about 24 hours to about 72 hours.

10. The method of claim 9, wherein the CPC is dried at room temperature C for about 1 hour to about 3 hours after drying in the oven.

11. A method of pre-coating pyrolysis char, the method comprising:
soaking a pyrolysis char (PC) in water to form a soaked PC;
sieving and vibrating the soaked PC to remove excess water;
mixing a cement material with the soaked PC to create a coated pyrolysis char (CPC); and
drying the CPC.

12. The method of claim 11, wherein the CPC is dried in an oven at about 30° C. to about 50° C. for about 24 hours to about 72 hours.

13. The method of claim 12, wherein the CPC is dried at room temperature C for about 1 hour to about 3 hours after drying in the oven.

14. The method of claim 11, wherein the soaked PC is sieved with a mesh having a mesh size from about 0.1 mm to about 0.2 mm.

15. The method of claim 11, wherein the vibrating occurs for about 15 second to about 120 seconds.
